(19) United States
(12) Patent Application Publication
(10) Pub. No.: US 2018/0079078 A1
(43) Pub. Date: Mar. 22, 2018

(54) ROBOT SIMULATION DEVICE

(71) Applicant: FANUC CORPORATION, Yamanashi (JP)

(72) Inventors: Yoshiharu NAGATSUKA, Yamanashi (JP); Norio TAKEI, Yamanashi (JP)

(21) Appl. No.: 15/678,577

(22) Filed: Aug. 16, 2017

(30) Foreign Application Priority Data
Sep. 20, 2016 (JP) 2016-182521

(51) Int. Cl. B25J 9/16

(52) U.S. Cl. CPC B25J 9/1671; G05B 2219/36071; B25J 9/1682

(57) ABSTRACT

A robot simulation device includes a robot-information acquiring unit that performs communication with control units of a plurality of robots included in a robot system and acquires hardware information and software information on the plurality of robots, a change determining unit that determines, on the basis of the acquired software information, whether an operation program is changed, and an evaluating unit that, when the change determining unit determines that the operation program is changed, performs a simulation of operations of the plurality of robots using the hardware information and the software information acquired by the robot-information acquiring unit and evaluates the operation program.

### CROSS-REFERENCE TO RELATED APPLICATIONS

This application claims the benefit of and claims priority to Japanese Patent Application No. 2016-182521, filed on Sep. 20, 2016, the entire content of which is incorporated herein by reference.

### FIELD OF THE INVENTION

The present invention relates to a robot simulation device.

### BACKGROUND OF THE INVENTION

There has been known a robot simulation device that performs a simulation of the operation of a robot offline (see, for example, Japanese Unexamined Patent Application Publication No. 2001-105359).

### SUMMARY OF THE INVENTION

According to an aspect of the present invention, there is provided a robot simulation device including: a robot-information acquiring unit that performs communication with control units of a plurality of robots included in a robot system and acquires hardware information and software information on the plurality of robots; a change determining unit that determines, on the basis of the software information acquired by the robot-information acquiring unit, whether an operation program is changed; and an evaluating unit that, when the change determining unit determines that the operation program is changed, performs a simulation of operations of the plurality of robots using the hardware information and the software information acquired by the robot-information acquiring unit and evaluates the operation program.

### BRIEF DESCRIPTION OF THE DRAWINGS

FIG. 1 is a block diagram showing a robot simulation device according to an embodiment of the present invention.

FIG. 2 is a block diagram for explaining a calculating unit in the robot simulation device shown in FIG. 1.

FIG. 3 is a flowchart for explaining processing in the robot simulation device shown in FIG. 1.

FIG. 4 is a flowchart for explaining a simulation routine in the flowchart of FIG. 3.

### DESCRIPTION OF EMBODIMENTS

A robot simulation device 1 according to an embodiment of the present invention is explained below with reference to the drawings.

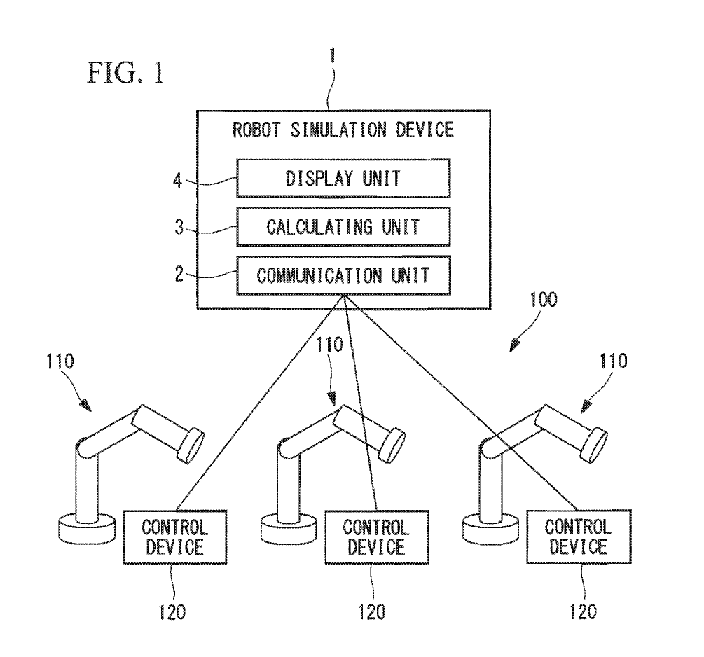

The robot simulation device 1 according to this embodiment is realized by a personal computer or the like. The robot simulation device 1 includes, as shown in FIG. 1, a communication unit (a robot-information acquiring unit) 2 that performs communication with control devices (control units) 120 of a plurality of robots 110 included in a robot system 100 including the robots 110, a calculating unit 3 that performs calculation on the basis of information acquired by the communication unit 2, and a display unit (a notifying unit) 4 that displays a result of the calculation by the calculating unit 3.

The communication unit 2 acquires hardware information and software information on the robots 110 from the control devices 120 of the robots 110.

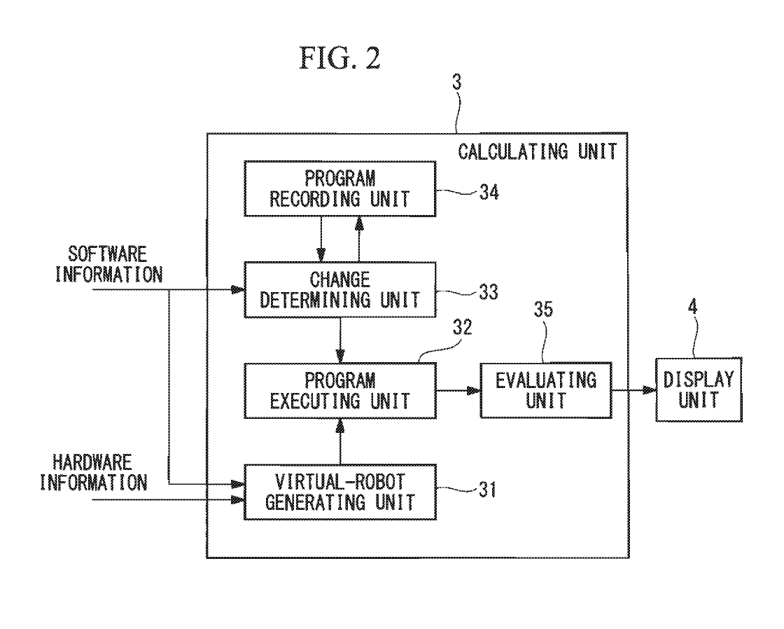

The calculating unit 3 includes, as shown in FIG. 2, a virtual-robot generating unit 31 that configures a virtual robot on the basis of the hardware information and the software information acquired by the communication unit 2 and a program executing unit 32 that carries out a simulation for executing an operation program with the generated virtual robot.

The calculating unit 3 includes a change determining unit 33 that determines, on the basis of software information acquired by communication, whether an operation program is changed and a program recording unit 34 that records the operation program.

The change determining unit 33 compares, every time software information is sent to the change determining unit 33, an operation program included in new software information and the latest operation program recorded in the program recording unit 34 and determines whether the operation program is changed.

When determining that the operation program is changed, the change determining unit 33 adds, as the latest operation program, the operation program after the change to operation programs recorded in the program recording unit 34.

When determining that the operation program is changed, the change determining unit 33 sends an operation program included in the latest software information to the program executing unit 32.

The program executing unit 32 performs a simulation by executing, with a virtual robot sent from the virtual-robot generating unit 31, the operation program sent from the change determining unit 33. An evaluating unit 35 is connected to the program executing unit 32. The program executing unit 32 outputs a simulation result to the evaluating unit 35.

The evaluating unit 35 evaluates the simulation result concerning predetermined evaluation indicators.

Examples of the evaluation indicators include a cycle time, power consumption, and presence or absence of interference between the robots 110.

The evaluating unit 35 determines whether the cycle time achieves a predetermined cycle time, determines the power consumption is equal to or smaller than a predetermined threshold, or determines, using an interference detecting unit (not shown in the figure) included in the evaluating unit 35, whether interference between the robots 110 occurs. When a problem occurs, the evaluating unit 35 notifies to that effect in the display unit 4 and outputs an evaluation result to the display unit 4. The display unit 4 is, for example, a monitor.

Action of the robot simulation device 1 according to this embodiment configured as explained above is explained below.

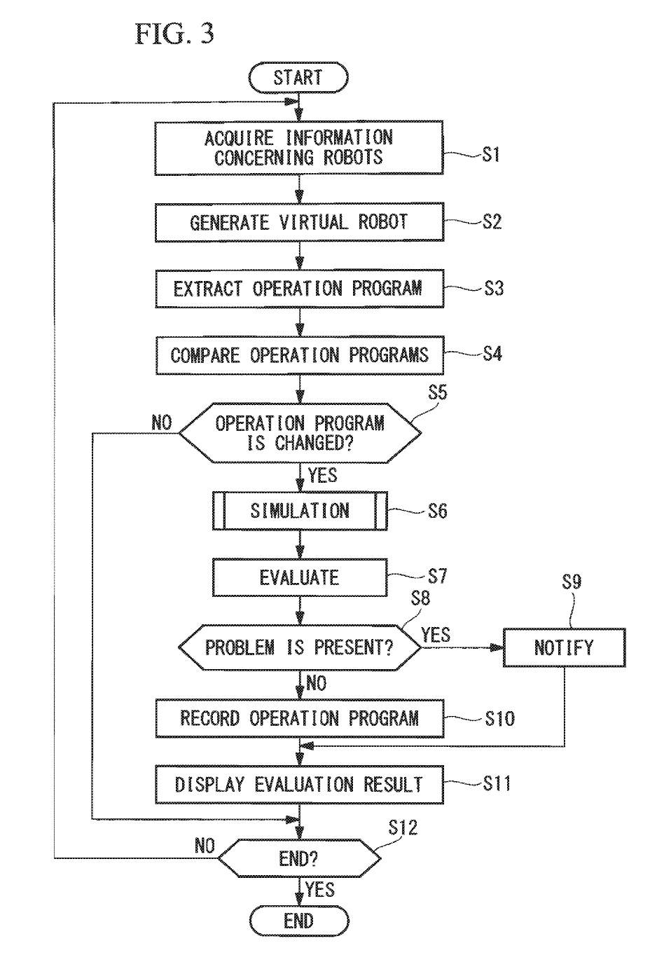

To carry out, using the robot simulation device 1 according to this embodiment, a simulation of the robot system 100 including the plurality of robots 110, as shown in FIG. 3, first, hardware information and software information on the robots 110 from the control devices 120 of the robots 110 are input to the robot simulation device 1 through communication (step S1).

When the hardware information and the software information are input, the virtual-robot generating unit 31 generates virtual robots of the robots 110 and sends the virtual robots to the program executing unit 32 (step S2). When the software information is input, the change determining unit 33 extracts an operation program included in the software information (step S3).

The change determining unit 33 compares the extracted operation program with an operation program recorded in the program recording unit 34 (step S4). The change determining unit 33 determines, as a result of the comparison, whether the extracted operation program and the latest operation program recorded in the program recording unit 34 are different (step S5). When the extracted operation program and the latest operation program are different, the extracted operation program is sent to the program executing unit 32. The change determining unit 33 determines that an operation program extracted first in a state in which the latest operation program is not recorded in the program recording unit 34 is also different from the recorded latest operation program.

The program executing unit 32 executes the operation program sent from the change determining unit 33 using the virtual robots sent from the virtual-robot generating unit 31 to thereby perform a simulation (step S6) and outputs a simulation result to the evaluating unit 35.

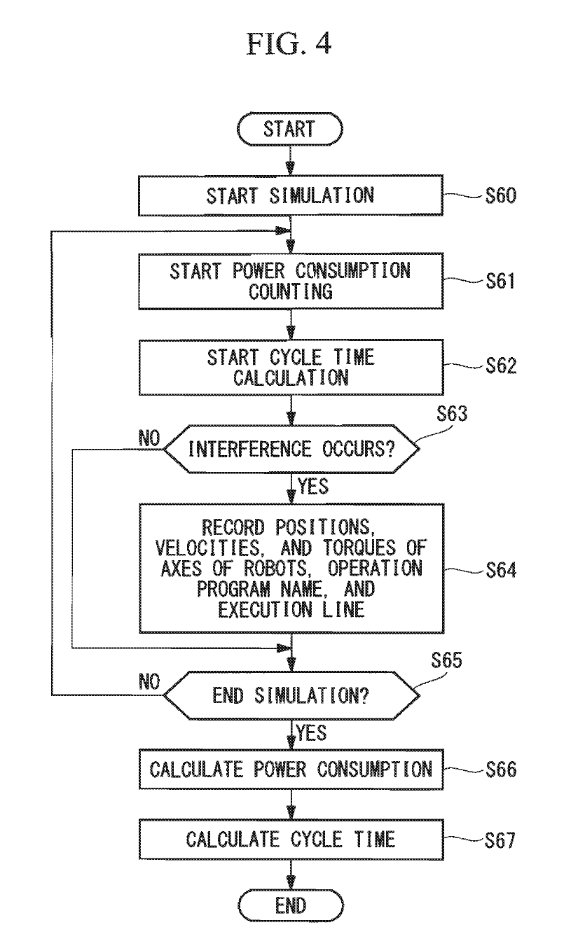

When the simulation is started (step S60), as shown in FIG. 4, the program executing unit 32 starts counting of power consumption and a cycle time (steps S61 and S62) and determines whether interference occurs between the robots 110 or between the robots 110 and a peripheral device (step S63). When detecting that interference occurs, the program executing unit 32 records positions, velocities, and torques of the axes of the robots 110 at a point in time of the interference, a name of an operation program being executed, and an execution line at the time when the interference occurs (step S64) and continues the simulation (step S65). After the simulation ends, the program executing unit 32 calculates power consumption and a cycle time (steps S66 and S67).

The evaluating unit 35 evaluates a simulation result concerning evaluation indicators and outputs an evaluation result to the display unit 4 (step S7).

The evaluating unit 35 determines in which of the evaluation indicators a problem is present as a result of the evaluation (step S8). When a problem is present, that is, when the cycle time does not achieve the predetermined cycle time, when the power consumption exceeds the predetermined threshold, or when interference occurs, the evaluating unit 35 notifies to that effect (step S9) and displays the evaluation result (step S11).

As a result of the comparison in step S5, when the operation program extracted anew is not changed from the latest operation program recorded in the program recording unit 34, the change determining unit 33 determines whether an end instruction for the simulation is input (step S12).

As a result of step S8, when a problem is absent in the evaluation result, the change determining unit 33 adds the operation program after the change to the program recording unit 34 as the latest operation program (step S10), and the process from step S11 is carried out.

When the end instruction for the simulation is not input in step S12, the process from step S1 is repeated.

In this way, with the robot simulation device 1 according to this embodiment, when the control device 120 of any one of the plurality of robots 110 changes an operation program, the change determining unit 33 determines presence or absence of a change. Only when a problem is absent in a simulation result obtained by using the operation program after the change, the operation program after the change is recorded as a new operation program. Therefore, there is an advantage that, even when an operation program is, for example, changed by the operator in the actual system, it is possible to evaluate the operation of the robots 110 in the system through the simulation.

Note that, in this embodiment, as a result of performing the simulation using the operation program after the change, when no problem occurs in all the evaluation indicators, the operation program is recorded in the program recording unit 34. Therefore, the simulation may be carried out by switching all recorded operation programs to make it possible to compare power consumptions and cycle times in a plurality of operation programs.

From the above-described embodiment, the following invention is derived.

According to an aspect of the present invention, there is provided a robot simulation device including: a robot-information acquiring unit that performs communication with control units of a plurality of robots included in a robot system and acquires hardware information and software information on the robots; a change determining unit that determines, on the basis of the software information acquired by the robot-information acquiring unit, whether an operation program is changed; and an evaluating unit that, when the change determining unit determines that the operation program is changed, performs a simulation of operations of the plurality of robots using the hardware information and the software information acquired by the robot-information acquiring unit and evaluates the operation program.

According to the aspect, the robot-information acquiring unit acquires the hardware information and the software information on the plurality of robots included in the robot system from the control units of the robots. The change determining unit determines whether the operation program is changed. When it is determined that the operation program is changed, the evaluating unit executes the simulation of the operation of the robot and evaluates the operation program.

That is, according to the aspect, a change of the operation program by the operator is monitored. When the operation program is changed, the simulation is performed to evaluate the operation program. Therefore, it is possible to evaluate the influence of the change of the operation program on the entire robot system and perform improvement and the like. For example, as a result of the change of the operation program, when a cycle time and power consumption of the entire robot system greatly increase or when it is found that interference between the robots occurs, it is possible to urge re-correction of the operation program.

In the aspect, the robot simulation device may further include a notifying unit that notifies a result of the evaluation by the evaluating unit.

Consequently, it is possible to carry out the re-correction of the operation program on the basis of the evaluation result notified by the notifying unit.

In the aspect, the evaluating unit may evaluate the operation program according to at least one of a cycle time and power consumption of the entire robot system.

Consequently, it is possible to re-correct the operation program such that the cycle time or the power consumption of the entire robot system decreases.

In the aspect, the evaluating unit may include an interference detecting unit that detects interference between the robots and, when the interference detecting unit detects interference, execution of the operation program may be recorded.

Consequently, by correcting the recorded execution of the operation program, it is possible to change the operation program to avoid the interference.

In the aspect, positions, velocities, and torques of the robots at the time when the interference is detected by the interference detecting unit may be recorded.

Consequently, it is possible to confirm a state of the robots at the time when the robots interfere with each other.

In the aspect, the robot simulation device may further include a program recording unit that records an operation program included in the software information acquired by the robot-information acquiring unit, and, when the change determining unit detects a change of the operation program, the changed operation program may be recorded in the program recording unit, and the evaluating unit may switch and evaluate a plurality of the operation programs recorded in the program recording unit.

Consequently, by switching the plurality of operation programs recorded in the program recording unit, it is possible to compare and evaluate the operation programs.

1. A robot simulation device, comprising:
a robot-information acquiring unit that performs communication with control units of a plurality of robots included in a robot system and acquires hardware information and software information on the plurality of robots;
a change determining unit that determines, on the basis of the software information acquired by the robot-information acquiring unit, whether an operation program is changed; and
an evaluating unit that, when the change determining unit determines that the operation program is changed, performs a simulation of operations of the plurality of robots using the hardware information and the software information acquired by the robot-information acquiring unit and evaluates the operation program.

2. The robot simulation device according to claim 1, further comprising a notifying unit that notifies a result of the evaluation by the evaluating unit.

3. The robot simulation device according to claim 1, wherein the evaluating unit evaluates the operation program according to at least one of a cycle time and power consumption of the entire robot system.

4. The robot simulation device according to claim 1, wherein:
the evaluating unit includes an interference detecting unit that detects interference between the plurality of robots, and
when the interference detecting unit detects interference, execution of the operation program is recorded.

5. The robot simulation device according to claim 4, wherein positions, velocities, and torques of the plurality of robots at the time when the interference is detected by the interference detecting unit are recorded.

6. The robot simulation device according to claim 1, further comprising a program recording unit that records an operation program included in the software information acquired by the robot-information acquiring unit, wherein
when the change determining unit detects a change of the operation program, the changed operation program is recorded in the program recording unit, and
the evaluating unit switches and evaluates a plurality of the operation programs recorded in the program recording unit.
